(19) United States
(12) Patent Application Publication
(10) Pub. No.: US 2012/0243224 A1
(43) Pub. Date: Sep. 27, 2012

(54) LIGHT EMITTING DEVICE AND SURFACE LIGHT SOURCE APPARATUS USING SAME

(76) Inventors: Takashi Kuwaharada, Kagoshima, (JP); Tooru Aoyagi, Kagoshima (JP)

(21) Appl. No.: 13/514,543

(22) PCT Filed: Dec. 27, 2010
(86) PCT No.: PCT/JP2010/007569

§ 371 Date: Jun. 7, 2012

(30) Foreign Application Priority Data
Jan. 13, 2010 (JP) 2010-004722

(51) Int. Cl. F21V 5/04

(52) U.S. Cl. 362/237; 362/311.1

(57) ABSTRACT

A light emitting device includes a light emitting element mounted on a lead frame which is a base; and a photochromic lens sealing the light emitting element. The light emitting element is in a rectangular parallelepiped shape and has a rectangular upper surface. The photochromic lens has a circular lower surface and has, at a side surface, a convex lens part inwardly inclined from bottom to top. Two flat parts are formed at the side surface by cutting off the photochromic lens in parallel with a long side of the upper surface of the light emitting element.

### TECHNICAL FIELD

The present invention relates to a light emitting device including a photochromic lens for adjusting the distribution of light emitted from a light emitting element and to a surface light source apparatus using the light emitting devices.

### BACKGROUND ART

A surface light source apparatus is used as a backlight apparatus for irradiating a liquid crystal display panel of, e.g., a flat-screen liquid crystal television on which an image is displayed with light from a back side of the liquid crystal display panel. Since it is required for the backlight apparatus to uniformly irradiate the liquid crystal display panel having a large display area with light, a plurality of light emitting devices are arranged in matrix at predetermined intervals on a large printed circuit board. In addition, it is required for each of the light emitting devices to efficiently spread light across a predetermined area.

A light emitting device configured such that, in order to fulfill the foregoing requirements, the distribution of light emitted from a light emitting element is adjusted by using the shape of a photochromic lens is described in, e.g., Patent Document 1.

Patent Document 1 describes the light emitting device as follows. For a light flux control member (photochromic lens) having an exit light control surface for controlling exit light from the light emitting element, a relationship θ5 /θ1>1 is satisfied, in which “θ1” represents an angle of light which, within a predetermined angular range, enters the light flux control member and reaches the exit light control surface with a line which passes through a point at which the light reaches the exit light control surface and is parallel to a reference optical axis of the light emitting device, and “θ5” represents an exit angle of light exiting through the exit light control surface with the reference optical axis of the light emitting device. In addition, the light flux control member is formed in such a shape that a light direction can be changed to a direction in which a value for θ5/θ1 is decreased with an increase in θ1.

That is, in the light emitting device described in Patent Document 1, the photochromic lens refracts light from the light emitting element toward the reference optical axis such that the degree of refraction is increased with distance from the reference optical axis (i.e., such that the light is refracted in an upward direction of the light emitting element). Thus, the light is prevented from exiting locally through, e.g., part of the light emitting device right above the light emitting element, and therefore can exit so as to uniformly and smoothly spread across an irradiation area.

As a light emitting element, not only a light emitting element formed so as to have a square top surface but also a rectangular parallelepiped light emitting element formed so as to have a rectangular top surface have been known (see, e.g., Patent Document 2).

A light emitting diode described in Patent Document 2 is configured as follows. The width of a light emitting diode element (light emitting element) is small in a short diameter direction of an oval cross section of a lens (mold part), i.e., a direction in which the radius of curvature of the oval is small. On the other hand, the width of the light emitting diode element is large in a long diameter direction of the oval cross section of the lens, i.e., a direction in which the radius of curvature of the oval is large. The light emitting diode element is die-bonded such that a longitudinal direction thereof is substantially coincident with the long diameter direction of the oval cross section of the mold part.

As illustrated in FIG. 13, in a rectangular parallelepiped light emitting element 100, a light exit area is larger at a long side surface 102 than at a short side surface 101. Thus, light emission intensity through the long side surface 102 is higher than that through the short side surface 101. However, the following can be realized by a technique described in Patent Document 2. The oval photochromic lens is arranged over the light emitting element having the rectangular top surface, thereby obtaining a uniform irradiation light amount in planes each containing the long and short diameter directions of the photochromic lens. As a result, luminous intensity around the center of the light emitting element can be increased.

### CITATION LIST

### Patent Document

PATENT DOCUMENT 1: Japanese Patent Publication No. 2006-324256

PATENT DOCUMENT 2: Japanese Patent Publication No. H06-013661

### SUMMARY OF THE INVENTION

### Technical Problem

However, as illustrated in FIG. 14, if a photochromic lens 104 (the outline thereof is illustrated) is formed in a substantially oval shape and the light emitting element 100 is arranged in a center part of the photochromic lens 104 such that a long diameter direction of the oval of the photochromic lens 104 and a long side direction of the light emitting element 100 are coincident with each other, a curved surface R of the oval of the photochromic lens 104 intersecting the long diameter direction thereof is more convexly curved than a curved surface of a substantially hemispherical photochromic lens. Thus, a light distribution range in the long diameter direction of the oval of the photochromic lens 104 is narrowed. As a result, in the oval photochromic lens 104, a relationship Xmax>Ymax is satisfied for the light emission intensity. Since uniform light emission intensity cannot be obtained, the light emitting element cannot uniformly illuminate an irradiation area.

Thus, even for a rectangular parallelepiped light emitting element having a plurality of light emission surfaces with different light emission surface areas, a photochromic lens by which uniform light emission intensity can be obtained is required.

It is an objective of the present invention to provide a light emitting device which, even for a rectangular parallelepiped light emitting element having a plurality of light emission surfaces with difference light emission surface areas, uses a photochromic lens for maintaining the intensity of light emitted through a short side surface of the light emitting element and reducing the intensity of light emitted through a long side surface of the light emitting element to uniformly illuminate the entire area around the photochromic lens, and to provide a surface light source apparatus.

### Solution to the Problem

A light emitting device of the present invention includes a light emitting element mounted on a base; and a photochromic lens sealing the light emitting element. The light emitting element is in a rectangular parallelepiped shape and has a rectangular upper surface. The photochromic lens has a circular lower surface and has, at a side surface, a convex lens part inwardly inclined from bottom to top. Two flat parts are formed at the side surface by cutting off the photochromic lens in parallel with a long side of the upper surface of the light emitting element.

### Advantages of the Invention

In the light emitting device of the present invention, the degree of light convergence in a direction facing the long side surface is reduced, thereby reducing the intensity of light emitted through the long side surface. Even for the rectangular parallelepiped light emitting element having a plurality of light emission surfaces with different light emission surface areas, the photochromic lens for maintaining the intensity of light emitted through the short side surface and reducing the intensity of light emitted through the long side surface is used. Thus, the entire area around the photochromic lens can be uniformly illuminated.

### BRIEF DESCRIPTION OF THE DRAWINGS

FIG. 1 is a side view illustrating part of a surface light source apparatus of an embodiment of the present invention.

FIG. 2 is a view of part of a surface light source part of the surface light source apparatus illustrated in FIG. 1 from above.

FIGS. 3(A), 3(B), and 3(C) are views each illustrating a light emitting device of the embodiment of the present invention. FIG. 3(A) is a plan view. FIG. 3(B) is a front view. FIG. 3(C) is a right side view.

FIGS. 4(A), 4(B), and 4(C) are views each illustrating the light emitting device illustrated in FIG. 3 with a photochromic lens being detached. FIG. 4(A) is a plan view. FIG. 4(B) is a partial cross-sectional view along an A-A line of FIG. 4(A). FIG. 4(C) is a partial cross-sectional view along a B-B line of FIG. 4(A).

FIGS. 5(A) and 5(B) are views each illustrating a lead frame. FIG. 5(A) is a view illustrating a front side. FIG. 5(B) is a view illustrating a back side.

FIG. 6 is an enlarged cross-sectional view of a main part of the light emitting device illustrated in FIG. 4(B).

FIG. 7(A) and 7(B) are views each illustrating the state in which the lead frames are connected together so as to be arranged in matrix. FIG. 7(A) is a view illustrating a front side. FIG. 7(B) is a view illustrating a back side.

FIG. 8 is a graph illustrating an exit surface of the photochromic lens of the light emitting device.

FIG. 9 is a view provided for description of vertical and horizontal axes of the graph illustrated in FIG. 8.

FIG. 10 is a view provided for description of light distribution characteristics of the light emitting device.

FIG. 11 is view provided for description of light distribution in a foot part of the photochromic lens.

FIG. 12 is a view illustrating light emission intensity characteristics of the photochromic lens.

FIG. 13 is a perspective view illustrating a rectangular parallelepiped light emitting element.

FIG. 14 is a view illustrating light emission intensity characteristics when a substantially oval photochromic lens is arranged over a rectangular parallelepiped light emitting element.

### DESCRIPTION OF EMBODIMENTS

A light emitting device of an embodiment of the present invention is a light emitting device including a light emitting element mounted on a base; and a photochromic lens sealing the light emitting element. The light emitting element is in a rectangular parallelepiped shape and has a rectangular upper surface. The photochromic lens has a circular lower surface and has, at a side surface, a convex lens part inwardly inclined from bottom to top. Two flat parts are formed at the side surface by cutting off the photochromic lens in parallel with a long side of the upper surface of the light emitting element.

According to the light emitting device, since each of the flat parts is formed in the photochromic lens so as to face the long side surface of the substantially rectangular parallelepiped light emitting element, a function of a convexly curved lens is reduced at an exit surface of the photochromic lens facing the long side surface, and the degree of light convergence in a direction facing the long side surface is reduced. Thus, the intensity of light emitted through the long side surface can be reduced.

In the light emitting device, each of the flat parts may be in a tapered shape in which the flat part outwardly expands from an upper end to a lower end thereof

In the foregoing configuration, light emitted through the side surface of the light emitting element is upwardly refracted by the photochromic lens. Thus, the light travels in an upward direction of the light emitting element, and therefore light emitted through the long side surface can contributes to improvement of light emission intensity in the upward direction.

In the light emitting device, a curved recessed foot part may be formed at the lower end of the flat part of the photochromic lens.

In the foregoing configuration, light laterally emitted from the light emitting element is refracted by the foot part, and therefore the light can travel in the upward direction of the light emitting element.

A surface light source apparatus of the embodiment of the present invention includes a plurality of foregoing light emitting devices arranged in matrix at substantially equal intervals.

In the foregoing configuration, even for the rectangular parallelepiped light emitting element having a plurality of light emission surfaces with different light emission surface areas, the photochromic lens for maintaining the intensity of light emitted through the short side surface and reducing the intensity of light emitted through the long side surface is used. Thus, the surface light source apparatus can uniformly illuminate an irradiation area.

### EMBODIMENT

As the light emitting device and the surface light source apparatus of the embodiment of the present invention, an LED and a backlight apparatus of a liquid crystal television using the LEDs as a light source will be described as an example with reference to drawings.

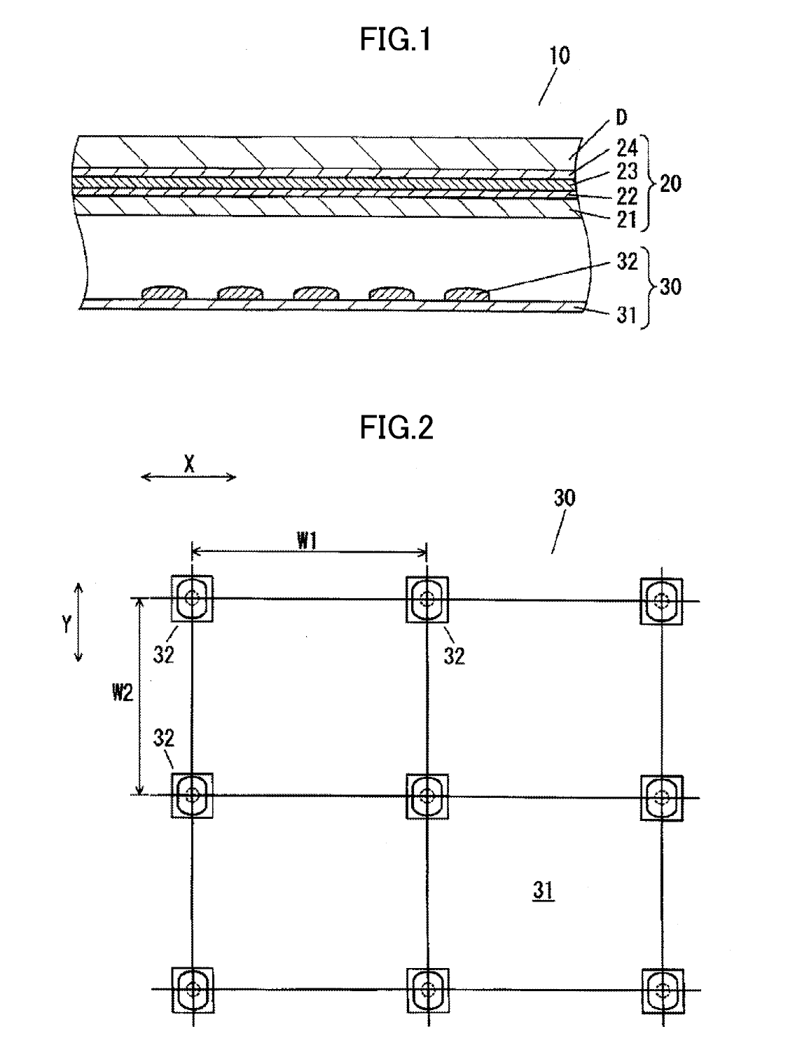

As illustrated in FIG. 1, a backlight apparatus 10 is used for a liquid crystal television having a wide screen in which a ratio of the width to the height of a display surface is 16:9, and is for illuminating a liquid crystal panel D from a back side thereof. The backlight apparatus 10 includes a light control member 20 adhered to a back surface of the liquid crystal panel D, and a surface light source part 30 arranged apart from the light control member 20 with a predetermined clearance.

The light control member 20 includes a diffuser panel 21, a diffuser sheet 22, a first light control sheet 23, and a second light control sheet 24.

The diffuser panel 21 is a resin plate which, in order to diffuse light of the surface light source part 30, is formed so as to have a rough surface as in a ground glass. The diffuser panel 21 may be made of, e.g., polycarbonate (PC) resin, polyester (PS) resin, or cyclic polyolefin (COP).

The diffuser sheet 22 is a resin sheet provided for further diffusing light diffused by the diffuser panel 21. The diffuser sheet 22 may be made of polyester.

The first light control sheet 23 has a prism surface at which triangular protrusions (linear triangular raised parts) made of acrylic resin are formed on polyester resin. The prism surface is formed so as to have a saw-tooth shaped cross section. The first light control sheet 23 collects light diffused by the diffuser panel 21 and the diffuser sheet 22 toward the liquid crystal panel D. The second light control sheet 24 collects light which is not collected by the first light control sheet 23. In addition, the second light control sheet 24 has a function to increase brightness with an increase in total light amount by reflecting S-waves toward the surface light source part 30 and then increasing P-waves passing through the liquid crystal panel D. In the foregoing manner, a variation in brightness is prevented by the first light control sheet 23 and the second light control sheet 24.

As illustrated in FIG. 2, the surface light source part 30 includes a substrate 31 and a plurality of light emitting devices 32. In the surface light source part 30, the light emitting devices 32 are arranged in matrix, i.e., in two directions intersecting with each other, at predetermined intervals on the substrate 31. In the present embodiment, some of the plurality of light emitting devices 32 are substantially equally spaced at intervals W1 in an X direction (horizontal direction), and the other light emitting devices 32 are substantially equally spaced at intervals W2 in a Y direction (longitudinal direction). The substrate 31 is a printed circuit board configured such that a wiring pattern for supplying power to the light emitting devices 32 is formed on a large insulating substrate made of, e.g., epoxy resin.

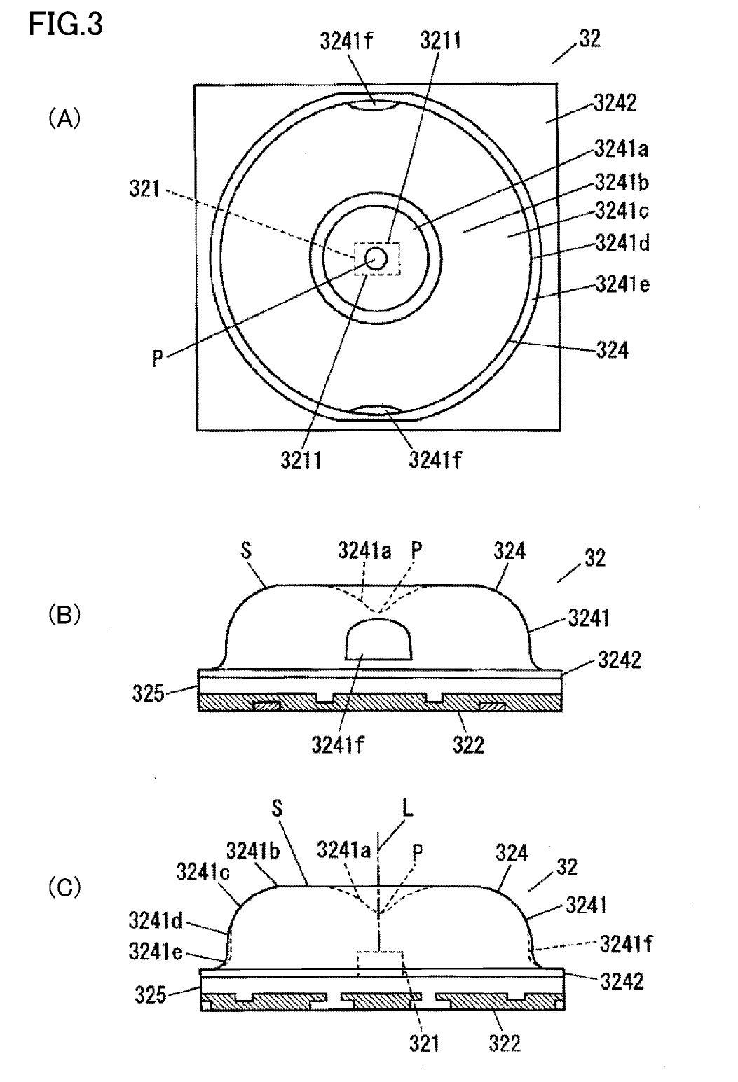

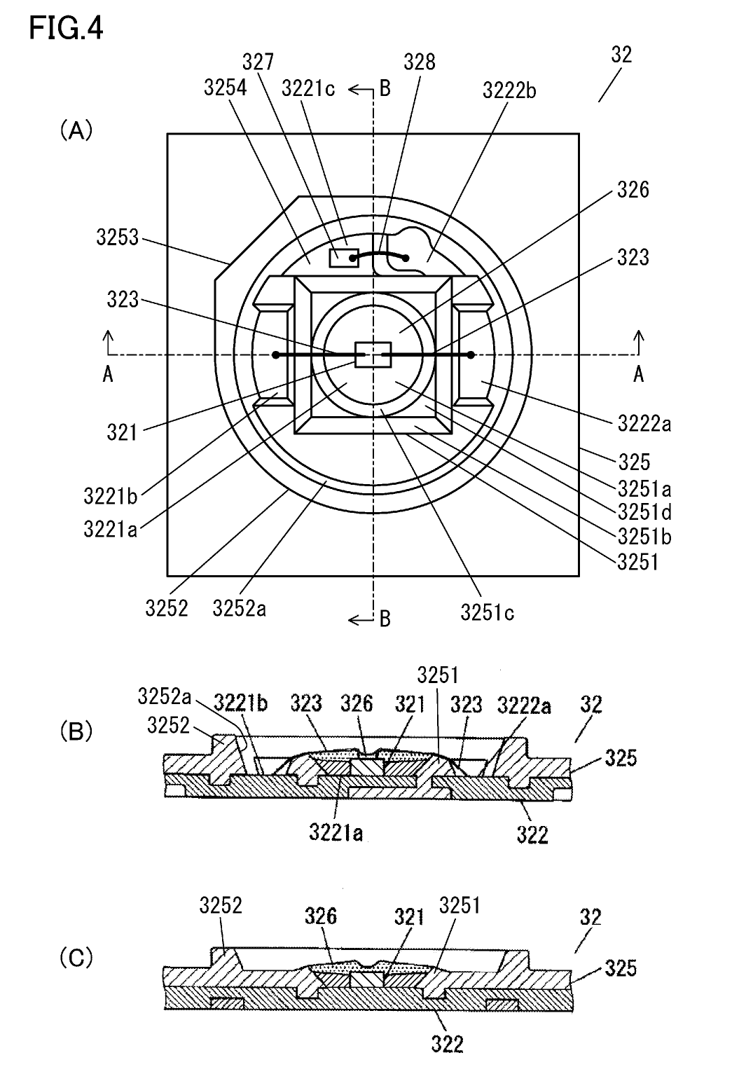

Next, a configuration of the light emitting device 32 will be described in detail with reference to FIGS. 3-6. FIGS. 3(A)-3(C) are a top view and two side views of the light emitting device 32. FIGS. 4(A)-4(C) are a top view and two cross-sectional views each illustrating an inside of the light emitting device 32 with a photochromic lens 324 being detached. The light emitting device 32 includes a light emitting element 321, a lead frame 322 which is a base, wires 323, the photochromic lens 324, a base part 325, a resin seal part 326 (see FIG. 4), and a protective element 327.

The light emitting element 321 is arranged at the center inside the photochromic lens 324. The light emitting element 321 is formed in a substantially rectangular parallelepiped shape so as to have a rectangular upper surface as viewed in the plane. The light emitting element 321 is a blue light emitting diode functioning as a point light source. The light emitting element 321 is configured such that an n-type semiconductor layer, a light emitting layer, a p-type semiconductor layer are formed in this order on a substrate, and that an n-side electrode formed on the n-type semiconductor layer exposed by etching part of the light emitting layer, part of the p-type semiconductor layer, and part of the n-type semiconductor layer and a p-side electrode connected onto the p-type semiconductor layer are provided. The n-side electrode and the p-side electrode of the light emitting element 321 are on an upper side of the substrate, and the substrate is die-bonded to the lead frame 322.

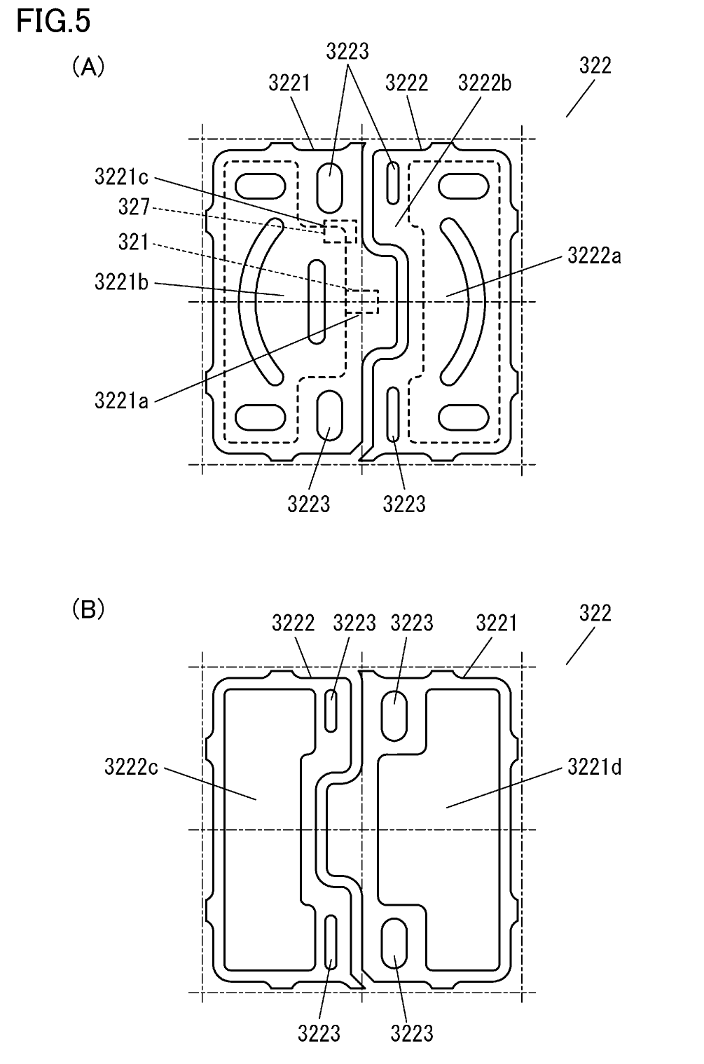

The lead frame 322 is formed by patterning a stack of plate layers made of, e.g., nickel or gold on a copper alloy plate. As illustrated in FIGS. 5(A) and 5(B), the lead frame 322 is formed so as to have a substantially square outline. The lead frame 322 includes two frames which are an anode frame 3221 and a cathode frame 3222. Two of four through-holes 3223 for preventing misalignment when the base part 325 is integrally formed with the lead frame 322 are provided in each of the anode frame 3221 and the cathode frame 3222.

As illustrated in FIG. 5(A), a die-bonding part 3221a on which the light emitting element 321 is mounted, a wire-bonding part 3221b in which the p-side electrode of the light emitting element 321 and the wire 323 are bonded together, and a protective element die-bonding part 3221c on which the protective element 327 is conductively mounted are provided in the pattern on a front surface of the anode frame 3221. A wire-bonding part 3222a in which the n-side electrode of the light emitting element 321 and the wire 323 are bonded together and a protective element wire-bonding part 3222b in which the protective element 327 and a wire 328 are bonded together are provided in the pattern on a front surface of the cathode frame 3222.

As illustrated in FIG. 5(B), an anode electrode 3221d is formed on a back surface of the anode frame 3221. A cathode electrode 3222c is formed on a back surface of the cathode frame 3222.

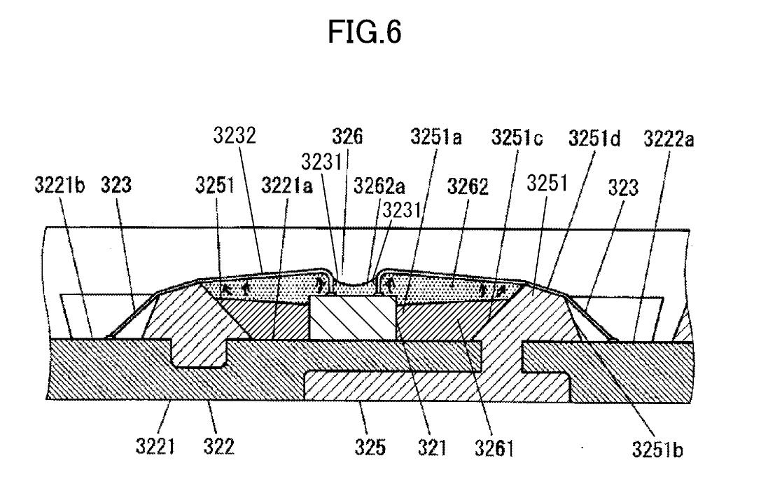

As illustrated in FIGS. 4 and 6, one of the wires 323 connects between the p-side electrode of the light emitting element 321 and the wire-bonding part 3221b of the lead frame 322, and the other wire 323 connects between the n-side electrode of the light emitting element 321 and the wire-bonding part 3222a of the lead frame 322. Each of the wires 323 is a wire for supplying power to the light emitting element 321. Each of the wires 323 may be a thin metal wire made of, e.g., Au.

As illustrated in FIG. 3, the photochromic lens 324 is made of silicon resin, and is for distributing light from the light emitting element 321 across a broad area. The photochromic lens 324 includes a substantially hemispherical lens body 3241, and is supported by a square flange 3242 at the periphery of the lens body 3241. A lower part of the photochromic lens 324 mounted on the flange 3242 is in a circular shape, and a cross section of the photochromic lens 324 along a plane parallel to the lead frame 322 is in a substantially circular shape.

In a position P of the photochromic lens 324 right above the light emitting element 321, a recess 3241a having a diameter gradually increasing from a bottom thereof in an upward direction L is provided.

The periphery of the recess 3241a is the uppermost part of the photochromic lens 324, and is a horizontal part 3241b extending in a direction perpendicular to the upward direction L. That is, the horizontal part 3241b is in a circular shape in which a circular hole opens at the center thereof. The periphery of the horizontal part 3241b is an arc curved part 3241c which is a convex lens part defining a gently curved surface. In a longitudinal section of the photochromic lens 324 along a plane containing the upward direction L, the arc curved part 3241c is in an outwardly protruding arc shape. A peripheral part 3241d which defines a substantially vertical surface is formed below the arc curved part 3241c. In an edge part at a lower end of the peripheral part 3241d, a foot part 3241e defining a gently curved recessed surface is formed.

The photochromic lens 324 is cut at positions opposing relative to the upward direction L, thereby forming flat parts 3241f along the upward direction L. The flat parts 3241f are formed so as to respectively face long side surfaces 3211 of the light emitting element 321. Each of the pair of flat parts 3241f is inclined so as to gradually approach the upward direction L of the light emitting element 321 from a lower end to an upper end thereof. In other words, the flat part 3241f is in a tapered shape in which the flat part 3241f outwardly expands from the upper end to the lower end thereof. In the present embodiment, the flat part 3241f is inclined about 2° with respect to the upward direction L.

As illustrated in FIG. 4, the base part 325 is white and is formed in a substantially plate shape. In the state in which the lead frame 322 is sandwiched between upper and lower molds, a space between the upper and lower molds is filled with epoxy resin, and the epoxy resin is cured. In such a manner, the base part 325 is molded. A first reflector 3251 which is a reflector including a frame 325 lb with an opening 3251a is provided in a center part of the base part 325. The lead frame 322 is exposed through the opening 3251a, and the opening 3251a is a space which is in a circular shape as viewed from the above and in which the light emitting element 321 is die-bonded. The frame 325 lb is formed so as to have a rectangular outline. The first reflector 3251 is provided such that an inner inclined surface 3251c thereof surrounds the light emitting element 321, and the inclined surface 3251c serves as a reflection surface by which light from the light emitting element 321 is reflected in the upward direction L (see FIG. 3(C)). The first reflector 3251 is positioned below an inclined surface of the recess 3241a (see FIG. 3(C)).

An upper end surface 3251d of the first reflector 3251 is a flat surface downwardly inclined from inside to outside.

A second reflector 3252 which is a circular reflector for the first reflector 3251 is provided outside the first reflector 3251. The second reflector 3252 is provided on a concentric circle of the first reflector 3251, which has the light emitting element 321 as the center thereof. An inner inclined surface 3252a of the second reflector 3252 serves as a reflection surface by which light leaking through the inclined surface 3251c of the first reflector 3251 or light reflected back by an exit surface S (see FIG. 3(B) or 3(C)) of the photochromic lens 324 is reflected. The inclined surface 3252a of the second reflector 3252 is formed such that an inclination angle thereof is greater than that of the inclined surface 3251c of the first reflector 3251. The second reflector 3252 and the components on an inner side relative to the second reflector 3252 are covered and sealed by the photochromic lens 324.

Part of the second reflector 3252 is cut off, thereby forming a flat part. The flat part is a polarity indicator 3253 by which the positions of the electrodes of the light emitting device 32 can be visually checked.

An opening 3254 in which a space to which the wire from the light emitting element 321 is bonded and a space in which the protective element 327 is die-bonded or wire-bonded are ensured on both sides of the light emitting element 321 is provided between the first reflector 3251 and the second reflector 3252.

As illustrated in FIG. 6, the resin seal part 326 is formed inside the first reflector 3251. The resin seal part 326 includes a first seal part 3261 and a second seal part 3262. The first seal part 3261 is made of transparent silicon resin, and is formed so as to surround the periphery of the light emitting element 321 other than a top surface (upper surface) thereof. The second seal part 3262 is formed on the first seal part 3261, and is made of silicon resin containing a phosphor. The phosphor is excited by blue light emitted from the light emitting element 321, and emits yellow light which is light having the complementary color of the blue light. Light exiting through the second seal part 3262 is white light because the blue light from the light emitting element 321 and the yellow light from the phosphor are mixed together. As the phosphor, a silicate phosphor or a YAG phosphor may be used.

As illustrated in FIG. 4, the protective element 327 functions as a protective circuit for protecting the light emitting element 321 from overvoltage. In the present embodiment, the protective element 327 is a zener diode. However, a diode, a capacitor, a resistor, or a varistor may be used. The protective element 327 may not be provided if the withstand voltage of the light emitting element 321 is sufficient.

The light emitting device 32 configured as described above may be manufactured by the following steps.

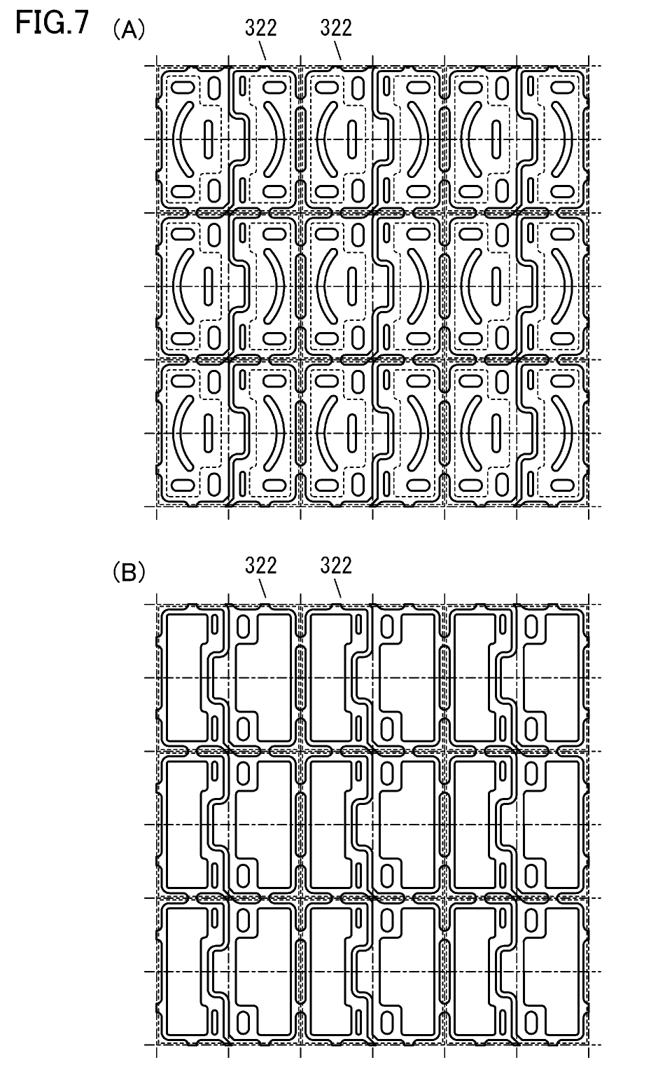

(1) First, as illustrated in FIGS. 7(A) and 7(B), a large metal plate is punched out to form lead frames 322 which are patterned to be arranged in matrix.

(2) The lead frames 322 arranged in matrix are clamped between molds, and base parts 325 each including a first reflector 3251 and a second reflector 3252 are molded by transfer molding (see FIGS. 4(A), 4(B), and 4(C)).

(3) A light emitting element 321 is mounted on (die-bonded to) each of die-bonding parts 3221a of anode frames 3221. Further, a protective element 327 is mounted on each of protective element die-bonding parts 3221c (see FIG. 5(A)).

(4) As illustrated in FIG. 6, first bonding is performed by bonding a wire 323 to an n-side electrode positioned at each of top surfaces (upper surfaces) of the die-bonded light emitting elements 321. The wire 323 extends in the vertical direction until the wire 323 reaches a position higher than an upper end of an inclined surface 3251c of the first reflector 3251, and then extends toward the first reflector 3251. Subsequently, after the 323 extends over the first reflector 3251 so as to contact the upper end of the first reflector 3251 or extend close to the upper end of the first reflector 3251, second bonding is performed by bonding the wire 323 to a wire-bonding part 3221b. In the foregoing manner, the wire 323 is connected. In the similar manner, a wire 323 is connected from a p-side electrode to a wire-bonding part 3222a. In the light emitting device 32 of the present embodiment, the wire 323 is connected so as to contact the upper end of the first reflector 3251. However, as long as the level of sealing resin forming a second seal part 3262 rises without leaking from the first reflector 3251 upon application of the sealing resin and then contacts the wire 323, the wire 323 may be connected so as to extend close to the upper end of the first reflector 3251 without the contact of the wire 323 with the upper end of the first reflector 3251. Wire bonding is performed to connect the protective element 327 to a protective element wire-bonding part 3222b through a wire 328 (see FIG. 4(A)).

(5) A space around the light emitting element 321 inside the first reflector 3251 is filled with transparent silicon resin which is in a liquid form, and the transparent silicon resin is cured. In such a manner, a first seal part 3261 is formed. The amount of transparent silicon resin to be applied is adjusted to such an amount that the top surface (upper surface) of the light emitting element 321 is not covered by the transparent silicon resin.

(6) Silicon resin which is liquid sealing resin containing a phosphor is applied onto the light emitting element 321 and is cured, thereby forming a second seal part 3262 on both of the light emitting element 321 and the first seal part 3261. The amount of phosphor-containing silicon resin to be applied is adjusted to such an amount that the level of silicon resin rises beyond an opening of the first reflector 3251 due to surface tension and pull-up of the silicon resin by the wire 323 and that the silicon resin can be prevented from leaking from the first reflector 3251 due to an excessive rise in level of silicon resin.

After the second seal part 3262 is formed by filling the first reflector 3251 with the liquid sealing resin, the sealing resin filling the first reflector 3251 up to a level close to the upper end of the first reflector 3251 comes into contact with the wire 323 contacting the upper end of the first reflector 3251, and is pulled up by the wire 323. Thus, the sealing resin extends to the upper end of the first reflector 3251 (movement indicated by arrows in FIG. 6).

In addition, the sealing resin is pulled up by the wire 323 extending from the top surface of the light emitting element 321 in the vertical direction (movement indicated by arrows in FIG. 6). The level of sealing resin pulled up by the wire 323 contacting the upper end of the first reflector 3251 and the wire 323 extending from the top surface of the light emitting element 321 in the vertical direction rises along the wire 323. Such a rise in level allows the second seal part 3262 to be a sealing resin layer having a thickness which gradually increases from the upper end of the first reflector 3251 to the center and containing the phosphor.

The sealing resin is cured in the state in which the sealing resin contacts the wire 323 passing above the upper end of the first reflector 3251, thereby forming a resin seal part 326 having a predetermined thickness without leakage of the sealing resin from the upper end of the first reflector 3251. Thus, the thickness of the second seal part 3262 can be ensured as compared to the state in which the wire 323 is apart from the upper end of the first reflector 3251.

In the foregoing state, a depression 3262a of the resin seal part 326 is formed between vertical parts 3231 of the pair of wires 323 extending from the electrodes formed at the top surface of the light emitting element 321 in the vertical direction. Since the pair of wires 323 are connected to the electrodes opposing each other relative to the center of the light emitting element 321, respectively, the depression 3262a is positioned right below a recess 3241a (see FIG. 3(C)) of a photochromic lens 324. The depression 3262a lower than surroundings is formed because the level of sealing resin in a substantially horizontal part 3232 of the wire 323 rises by contact of the substantially horizontal part 3232 with the sealing resin spreading from the upper end of the first reflector 3251 along the wire 323 and there is no wire part supporting the sealing resin between the vertical parts 3231 of the wires 323.

(7) At this point, the second reflector 3252 (see FIGS. 4(A) and 4(B)) may be filled with transparent silicon resin which is in a liquid form, thereby sealing the wires 323.

The sealing of the wires 323 can be omitted as long as the wires 323 are resistant to disconnection when the photochromic lens 324 is molded.

(8) The photochromic lens 324 is molded on the base part 325 by transfer molding using a mold formed in a shape corresponding to the shape of the photochromic lens 324 with a cavity (see FIGS. 3(A), 3(B), and 3(C)). In such a manner, the light emitting element 321 is sealed by the photochromic lens 324.

(9) The lead frames 322 are separated into pieces by a dicer, thereby forming light emitting devices 32.

Next, the exit surface S of the photochromic lens 324 of the light emitting device 32 of the embodiment of the present invention will be described with reference to drawings.

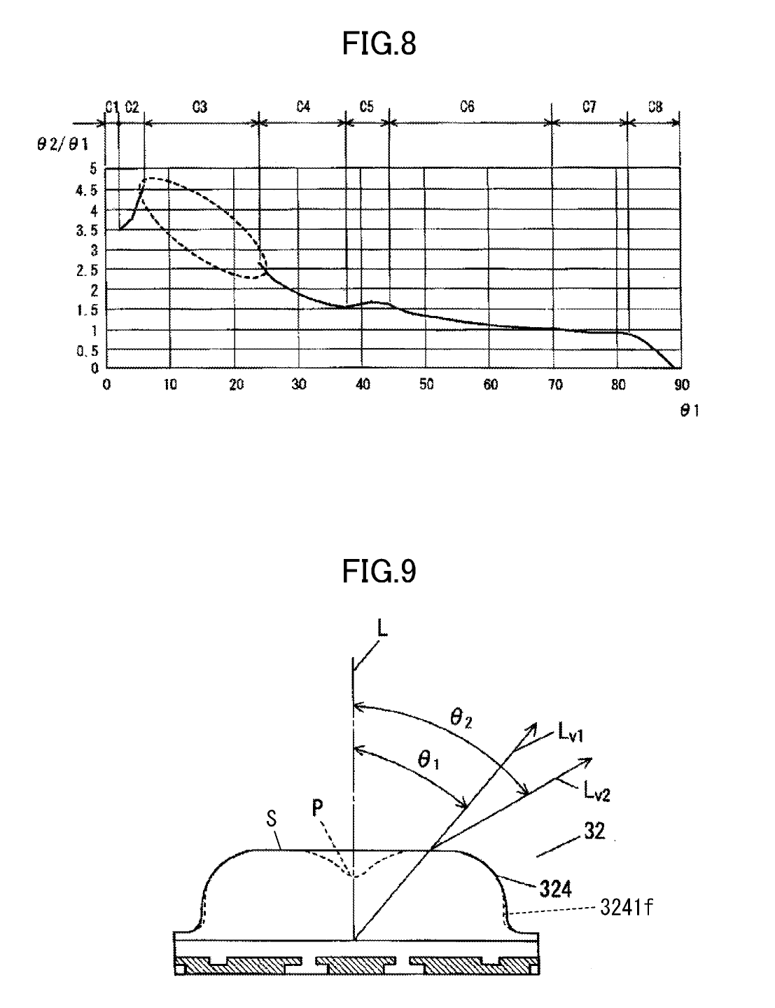

The curved surface shape of the exit surface S of the photochromic lens 324 can be represented by a graph illustrated in FIG. 8, in which the horizontal axis represents “θ1” and the vertical axis represents “θ2/θ1.” Note that, as illustrated in FIG. 9, “θ1” represents an angle of a virtual line L_{V1} indicating a direction in which light emitted from the light emitting element 321 travels straight through the exit surface S, with the upward direction L, and “θ2” represents an angle of a virtual line L_{V2} indicating a direction in which light refracted by the exit surface S travels, with the upward direction L. The graph of FIG. 8 representing the exit surface S illustrates the case where light passes through the flat part 3241f when passing through the exit surface S. Note that the refractive index of the photochromic lens 324 is 1.41.

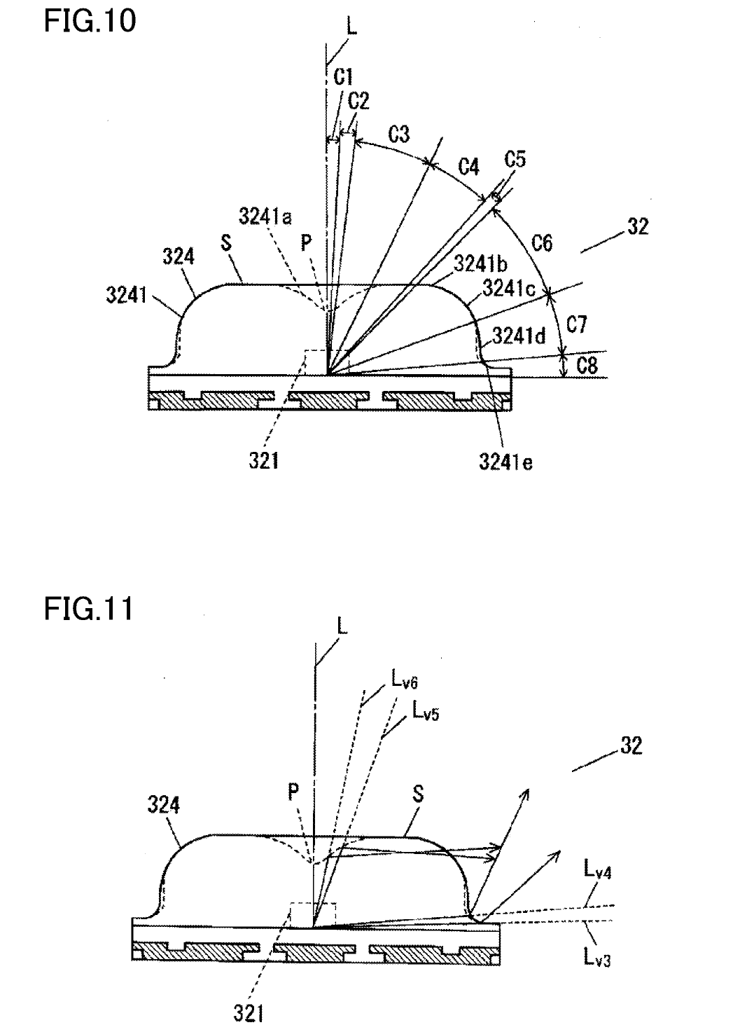

As illustrated in FIGS. 8 and 10, the bottom (0°≦θ1≦3°) of the recess 3241a positioned right above the upper surface of the light emitting element 321 serves as a reflection surface at which light is totally reflected by the exit surface S in a direction away from the upward direction L (see a range C1). Light is reflected by the reflection surface such that a reflection angle gradually increases with distance from the position P right above the light emitting element 321 (with an increase in θ1). Thus, in the region corresponding to the range C1 (bottom of the recess 3241a), light having high light emission intensity and traveling in the upward direction L of the light emitting element 321 is reflected without refraction.

The depression 3262a of the second seal part 3262 is formed between the vertical parts 3231 of the wires 323, and a thin part of the second seal part 3262 is formed between the wires 323. Thus, the degree of wavelength conversion of light passing through the depression 3262a by the phosphor is decreased (see FIG. 6). However, in the photochromic lens 324, the recess 3241a with the bottom serving as the reflection surface corresponding to the range C1 is provided in the position P right above the light emitting element 321. Thus, since light passing through the thin part of the second seal part 3262 between the wires 323 is totally reflected within the range C1, light traveling in the upward direction L does not travel straight and can be mixed with light surrounding an axis along the upward direction L. As a result, a chromaticity difference between light passing through a peripheral edge part of the second seal part 3262 and light passing through part of the second seal part 3262 between the wires 323 is less likely to be visually observed from above.

Next, for a range (3°≦θ1≦7°) corresponding to a region from the bottom of the recess 3241a to a lower end of the inclined surface of the recess 3241a, an increase in θ1 results in a greater refraction angle at which light is refracted by the exit surface S in the direction away from the upward direction L (see a range C2). Thus, for the range C2 corresponding to a peripheral region continuing to the outer periphery of a region corresponding to the range C1, compensation for light emission intensity for the range C1 corresponding to the region where light is totally reflected is achieved, and a refraction angle at which light is outwardly refracted by the exit surface S increases with distance from the position P to a light exit position. Thus, even if light passes through the exit surface S, intensive light emission in the upward direction L of the light emitting element 321 can be avoided, and compensation for light emission intensity decreased due to the total reflection in the region corresponding to the range C1 can be achieved.

Next, for a range (7°≦θ1≦24°) corresponding to a region from the lower end of the inclined surface of the recess 3241a to an opening end of the recess 3241a, such a region serves as a reflection surface at which light is totally reflected by the exit surface S in the direction away from the upward direction L (see a range C3). As in the region corresponding to the range C1, light is reflected by the reflection surface such that a reflection angle increases with distance from the position P right above the light emitting element 321. Thus, in the region corresponding to the range C3, light surrounding the axis along the upward direction L can be further dispersed outwardly with respect to the upward direction L.

Next, unlike the region corresponding to the range C2, for a range (24°≦θ1≦37°) corresponding to a region from the opening end of the recess 3241a to a middle part of the horizontal part 3241b, an increase in θ1 results in a smaller refraction angle at which light is refracted by the exit surface S (see a range C4). Thus, in the region corresponding to the range C4, compensation for light emission intensity for the range C3 corresponding to the region where light is totally reflected is achieved, and a refraction angle at which light is outwardly refracted by the exit surface S increases with distance from the position P to a light exit position. As a result, even if light passes through the exit surface S, the intensive light emission in the upward direction L can be reduced.

Next, in the middle part (37°≦θ1≦43°) of the horizontal part 3241b, an increase in θ1 results in a greater refraction angle at which light is refracted by the exit surface S (see a range C5).

Next, for a range (43°≦θ1≦70°) corresponding to a region from the middle part of the horizontal part 3241b to the peripheral part 3241d through the arc curved part 3241c (a region extending to near the flat part 32410, an increase in θ1 results in a smaller refraction angle at which light is refracted by the exit surface S (see a range C6).

Next, in the flat part 3241f (70°≦θ1≦82°), θ2/θ1 is less than 1, and light is refracted inwardly with respect to a direction in which the light travels straight through the exit surface S (see a range C7). This is because the flat part 3241f is inclined so as to gradually approach the upward direction L of the light emitting element 321 from the lower end to the upper end thereof. Thus, light from the light emitting element 321 can upwardly refracted when reaching the flat part 3241f, thereby allowing the light to travel in the upward direction L of the light emitting element 321. As a result, light through the long side surface 3211 can contribute to improvement of light emission intensity in the upward direction L.

In the foot part 3241e (82°≦θ1≦90°) positioned at the lower end of the peripheral part 3241d, θ2/θ1 is much less than 1, and light is refracted considerably inwardly with respect to a direction in which the light travels straight through the exit surface S. In addition, an increase in θ1 results in a greater refraction angle at which light is refracted by the exit surface S (see a range C8).

In the region corresponding to the range C8, light emitted from the light emitting element 321 is refracted upwardly (inwardly) with respect to virtual lines L_{V3} and L_{V4} each indicating a direction in which the light travels straight through the exit surface S as illustrated in FIG. 11. In the regions corresponding to the ranges C1-C6 illustrated in FIG. 10, light travels outwardly with respect to virtual lines L_{V5} and L_{V6} each indicating a direction in which the light travels straight through the exit surface S. Thus, the foot part 3241e corresponding to the range C8 refracts light laterally emitted from the light emitting element 321, thereby allowing the light to travel in the upward direction L of the light emitting element 321.

Since the light emitting device 32 of the present embodiment includes not only the first reflector 3251 but also the second reflector 3252, light emitted from the light emitting element 321 does not directly reach the foot part 3241e. However, when light reflected by the exit surface S reaches the foot part 3241e, the light is refracted so as to travel in the upward direction L of the light emitting element 321, and therefore such light can contribute to the improvement of light emission intensity.

As described above, in the light emitting device 32, the reflection surface at which light having the highest light emission intensity and traveling in the upward direction L of the light emitting element 321 is totally reflected by the exit surface S in the direction away from the position P right above the light emitting element 321 is formed in the region corresponding to the range C1. Thus, the position P is prevented from being an abnormally high brightness point. For the range C2 corresponding to the region continuing to the outer periphery of the region corresponding to the range C1, light emitted from the light emitting element 321 is refracted in the direction away from the upward direction L. Thus, the intensive light emission in the upward direction L can be avoided, and the compensation for light emission intensity decreased due to the total reflection in the region corresponding to the range C1 can be achieved. As a result, a variation in brightness can be reduced, thereby allowing broad and uniform illumination even by the light emitting element 321 having high brightness.

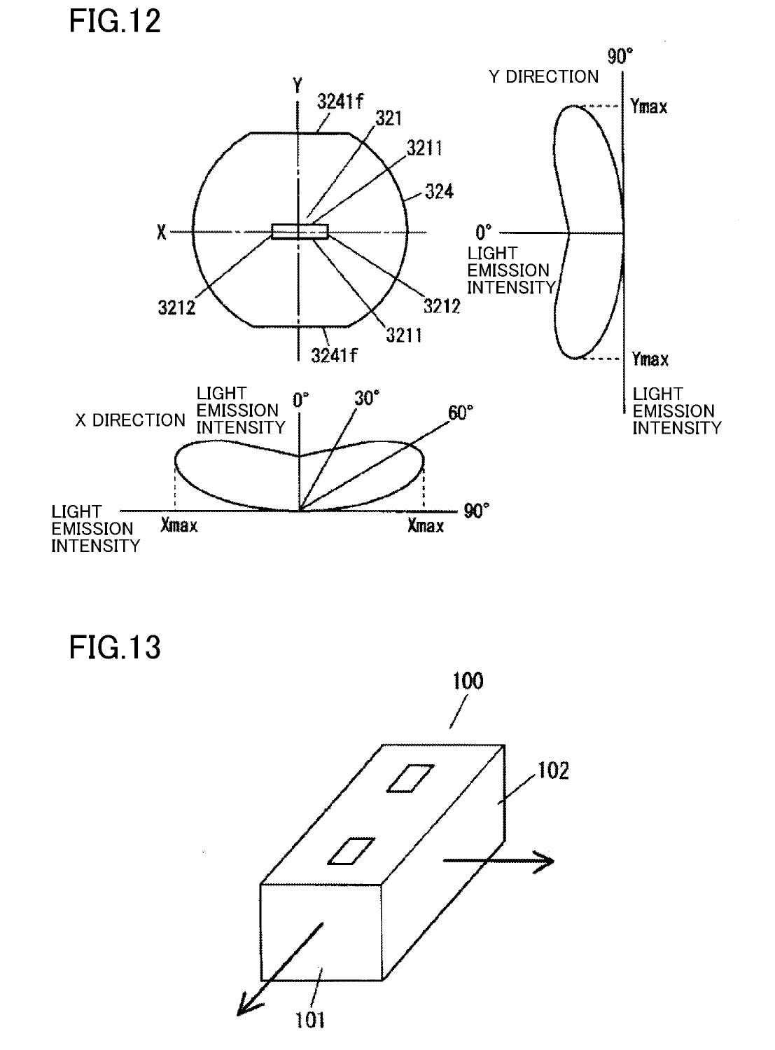

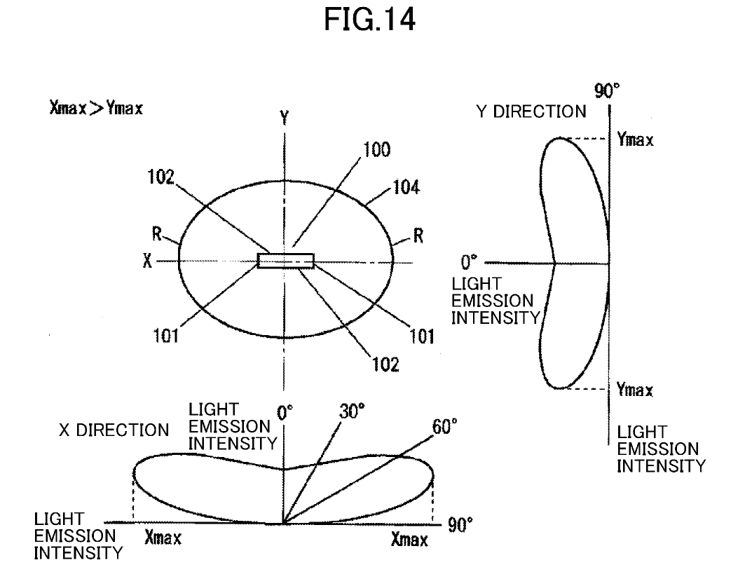

Next, light emission intensity characteristics of the light emitting device 32 will be described with reference to the drawings. Since the light emitting element 321 is formed in an elongated rectangular parallelepiped shape in the light emitting device 32, the brightness of light laterally emitted through the long side surface 3211 of the light emitting element 321 is higher than that through a short side surface 3212 of the light emitting element 321 as illustrated in FIG. 12. However, since each of the flat parts 3241f is formed in the photochromic lens 324 so as to face the long side surface 3211, a function of a convexly curved lens is reduced at the exit surface of the photochromic lens 324 facing the long side surface 3211, and the degree of light convergence is reduced. By providing the flat parts 3241f in a substantially hemispherical photochromic lens having a substantially circular light distribution pattern in the case where a light emitting element having a square upper surface is used, the photochromic lens 324 of the present embodiment can be formed even from such a photochromic lens. Thus, the light emission intensity of light through the long side surface 3211 can be reduced. For the light emission intensity, a relationship Xmax=Ymax (where the X direction indicates a direction facing the short side surface 3212 and the Y direction indicates a direction facing the long side surface 3211) can be satisfied. Thus, even if the rectangular parallelepiped light emitting element 321 having a plurality of light emission surfaces with different light emission surface areas is arranged in a center part of the photochromic lens 324 as a light source, the light emission intensity of light emitted through the short side surface 3212 can be maintained, and the light emission intensity of light emitted through the long side surface 3211 can be reduced. As a result, the entire area around the photochromic lens 324 can be uniformly illuminated.

As described above, since light can be uniformly distributed around the photochromic lens 324, the surface light source part 30 in which the light emitting devices 32 are arranged at equal intervals in the X direction (horizontal direction) and the Y direction (longitudinal direction) as illustrated in FIG. 2 can be used as the backlight apparatus 10.

### INDUSTRIAL APPLICABILITY

In the present invention, even for the rectangular parallelepiped light emitting element having the plurality of light emission surfaces with the difference light emission surface areas, the photochromic lens for maintaining the intensity of light emitted through the short side surface of the light emitting element and reducing the intensity of light emitted through the long side surface of the light emitting element is used to uniformly illuminate the entire area around the photochromic lens. Thus, the present invention is useful as the light emitting device including the substantially hemispherical photochromic lens for adjusting the distribution of light emitted from the light emitting element and the surface light source apparatus using the light emitting devices.

### DESCRIPTION OF REFERENCE CHARACTERS

10 Backlight Apparatus
20 Light Control Member
21 Diffuser Panel
22 Diffuser Sheet
23 First Light Control Sheet
24 Second Light Control Sheet
30 Surface Light Source Part
31 Substrate
32 Light Emitting Device
321 Light Emitting Element
3211 Long Side Surface
3212 Short Side Surface
322 Lead Frame
3221 Anode Frame
3221a Die-Bonding Part
3221b Wire-Bonding Part
3221c Protective Element Die-Bonding Part
3221d Anode Electrode
3222 Cathode Frame
3222a Wire-Bonding Part
3222b Protective Element Wire-Bonding Part
3222c Cathode Electrode
3223 Through-Hole
323 Wire
3231 Vertical Part
3232 Horizontal Part
324 Photochromic Lens
3241 Lens Body
3241a Recess
3241b Horizontal Part
3241c Arc Curved Part (Convex Lens Part)
3241d Peripheral Part
3241e Foot Part
3241f Flat Part
3242 Flange
325 Base Part
3251 First Reflector
3251a Opening
3251b Frame
3251c Inclined Surface
3251d Upper End Surface
3252 Second Reflector
3252a Inclined Surface
3253 Polarity Indicator
3254 Opening
326 Resin Seal Part
3261 First Seal Part
3262 Second Seal Part
3262a Depression
327 Protective Element
328 Wire
C1-C8 Range
D Liquid Crystal Panel
L Upward Direction
P Position
S Exit Surface
Lᵥ₁-Lᵥ₆ Virtual Line
W1, W2 Interval

1. A light emitting device, comprising:
a light emitting element mounted on a base; and
a photochromic lens sealing the light emitting element,
wherein the light emitting element is in a rectangular parallelepiped shape and has a rectangular upper surface,
the photochromic lens has a circular lower surface and has, at a side surface, a convex lens part inwardly inclined from bottom to top, and
two flat parts are formed at the side surface by cutting off the photochromic lens in parallel with a long side of the upper surface of the light emitting element.

2. The light emitting device of claim 1, wherein
each of the flat parts is in a tapered shape in which the flat part outwardly expands from an upper end to a lower end thereof.

3. The light emitting device of claim 1, wherein
a curved recessed foot part is formed at the lower end of the flat part of the photochromic lens.

4. A surface light source apparatus, comprising:
multiple ones of the light emitting device of claim 1 arranged in matrix at substantially equal intervals.
